(19) United States
(12) Patent Application Publication
(10) Pub. No.: US 2024/0274785 A1
(43) Pub. Date: Aug. 15, 2024

(54) BATTERY ASSEMBLY AND MANUFACTURING METHOD THEREOF

(71) Applicants: BEIJING BOE TECHNOLOGY DEVELOPMENT CO., LTD., Beijing (CN); BOE Technology Group Co., Ltd., Beijing (CN)

(72) Inventors: Jiangbo Chen, Beijing (CN); Fanli Meng, Beijing (CN); Qiuyun Tan, Beijing (CN); Zeyuan Li, Beijing (CN); Hu Meng, Beijing (CN); Wei Guo, Beijing (CN); Ding Ding, Beijing (CN)

(73) Assignees: BEIJING BOE TECHNOLOGY DEVELOPMENT CO., LTD., Beijing (CN); BOE Technology Group Co., Ltd., Beijing (CN)

(21) Appl. No.: 18/022,904

(22) PCT Filed: Apr. 14, 2022
(86) PCT No.: PCT/CN2022/086767

§ 371 Date: Feb. 23, 2023

(51) Int. Cl. H01M 4/04; H01M 4/139; H01M 10/058; H01M 50/105

(52) U.S. Cl. CPC H01M 4/0471; H01M 4/0404; H01M 4/0426; H01M 4/139; H01M 10/058; H01M 50/105

(57) ABSTRACT

Provided are a battery assembly and a manufacturing method thereof. the battery assembly includes: an anode unit, which includes an anode current collector and an anode on the anode current collector, an electrolyte layer on a side of the anode remote from the anode current collector; and a cathode unit on a side of the electrolyte layer remote from the anode; the battery assembly further includes: an interface layer formed at a contact interface between the anode current collector and the anode.

### TECHNICAL FIELD

The present disclosure relates to the fields of batteries and photovoltaic technologies, and more particularly, to a battery assembly and a manufacturing method thereof.

### BACKGROUND

In recent years, commercial liquid lithium-ion batteries have caused multiple serious safety accidents in electronic products, electrically powered vehicles and other scenarios. The hidden source of these accidents lies in that flammable organic electrolyte is used in lithium-ion batteries, which tends to burn or even explode when the batteries have been over-charged or over-discharged, short circuited or the like. Although the safety of Li-ion battery can be improved to a certain extent by adding a flame retardant, using a high temperature resistant ceramic separator, optimizing the battery structure design and other measures, the potential safety hazards cannot be eliminated from the root. Therefore, replacing combustible organic electrolyte with non-combustible solid electrolyte is an effective way to improve the safety and reliability of lithium batteries.

However, the conventional bulk-type solid-state batteries are usually manufactured by using coating, extrusion, high-temperature sintering and other preparation processes, and the active materials, solid electrolyte and electrical conductive materials in the composite electrode structure exist in the form of a particle mixture, which cannot ensure a good contact at the electrode/electrolyte interface, resulting in large interface resistance and other problems. For biomedical devices, Internet of things (IOT) devices, micro-electromechanical systems (MEMS) devices and the like, which are limited in space, energy supply problems are generally solved by thin-film energy storage devices (namely, thin-film battery assemblies), such as solar cells, supercapacitors, and lithium ion batteries.

In the related art, a thin-film battery assembly mainly includes an anode current collector, an anode, an electrolyte and a cathode current collector and other film layers, in which the deposition temperature of the anode is high, and the crystallinity of the anode material is increased by high temperature. The process has high energy consumption and low production efficiency, cracking is prone to occur after the high temperature processing, and the process is not conducive to the large-scale production of thin-film batteries.

### SUMMARY

Embodiments of the present disclosure provide a battery assembly and a manufacturing method thereof, which allow for film formation at a low temperature, reduced cost, improved production efficiency, and facilitate large-scale production of thin-film batteries.

The present disclosure provides the following technical solutions.

A battery assembly, including:

an anode unit including an anode current collector and an anode on a side of the anode current collector remote from a substrate;

an electrolyte layer on a side of the anode remote from the substrate; and

a cathode unit on a side of the electrolyte layer remote from the substrate;

the battery assembly further includes: an interface layer formed at a contact interface between the anode current collector and the anode.

Illustratively, the anode current collector is made from an active metal X, and the active metal X includes a pre-hydrogen metal which is a metal located before metallic hydrogen in activity series of metals.

Illustratively, the active metal is selected from transition metal materials.

Illustratively, the active metal includes at least one or a combination of nickel, molybdenum, tin or lead.

Illustratively, the anode is made from a compound material containing lithium.

Illustratively, the anode is made from lithium oxide, and the interface layer includes a crystalline compound formed by crystallization of the metal X and the lithium oxide.

Illustratively, the cathode unit includes: a cathode on a side of the electrolyte layer remote from the anode, and a cathode current collector on a side of the cathode remote from the electrolyte layer; or,

the cathode unit only includes: a cathode current collector on a side of the electrolyte layer remote from the anode.

Illustratively, the battery assembly is a bulk-type battery, and the anode unit and the cathode unit are combined.

Illustratively, the battery assembly is a thin-film battery, and further includes a substrate on which the anode unit is located.

Illustratively, the substrate is a flexible substrate or a rigid substrate.

Illustratively, the flexible substrate is made from one or more of polyimide, polymethyl methacrylate, polyethylene terephthalate and polyvinyl chloride;

the rigid substrate is made from one or more of a metal, or a rigid resin material.

Illustratively, the interface layer is a crystalline interface layer, and the interface layer has a thickness of 5-10 nm.

Illustratively, the anode current collector includes a first face proximate to the anode and a second face opposite to the first face, and the first face includes a first region covered by the anode and a second region not covered by the anode, wherein a height of an interface between the first region and the interface layer relative to the second face is lower than a height of the second region relative to the second face.

Illustratively, the interface layer includes a first subregion and a second subregion, a content of a high-valence metal X is greater than a content of a low-valence metal X in the first subregion, a content of the low-valence metal X is greater than a content of the high-valence metal X in the second subregion, a minimum distance between the first subregion and the anode is less than a minimum distance between the second subregion and the anode, and a minimum distance between the second subregion and the anode current collector is less than a minimum distance between the first subregion and the anode current collector.

An embodiment of the present disclosure further provides a method for manufacturing a battery assembly, which is applied for manufacture the battery assembly as described above. The method includes the following steps:

forming an anode current collector;

depositing an anode on a side of the anode current collector remote from the substrate;

annealing the anode to form an interface layer at a contact interface between the anode current collector and the anode; and

forming an electrolyte layer and a cathode unit on a side of the anode remote from the anode current collector.

Illustratively, the forming an anode current collector specifically includes:

providing a substrate, depositing a metal layer on the substrate by means of direct current (DC) magnetron sputtering, and patterning the metal layer to obtain the anode current collector, wherein the anode current collector is made from an active metal X, and the active metal X includes a pre-hydrogen metal which is a metal located before metallic hydrogen in activity series of metals; or,

providing a metal substrate made from an active metal X as the anode current collector.

Illustratively, the depositing an anode on a side of the anode current collector remote from the substrate specifically includes:

depositing an anode by means of radio frequency magnetron sputtering, wherein the anode is made from a compound material containing lithium.

Illustratively, the anode is annealed at an annealing temperature of 25-800 degrees Celsius for 0.5-5 hours.

Illustratively, the forming an electrolyte layer and a cathode unit on a side of the anode remote from the anode current collector specifically includes:

depositing an electrolyte layer by means of radio frequency magnetron sputtering;

depositing a cathode on a side of the electrolyte layer remote from the substrate and depositing a cathode current collector on a side of the cathode remote from the electrolyte layer; or depositing a cathode on a side of the electrolyte layer remote from the substrate;

or,

providing a cathode member including an electrolyte layer and a cathode unit, and combining the anode current collector and the anode, which are taken as a single member, with the cathode member.

The embodiments of the present disclosure have the following beneficial effects.

According to the battery assembly and the manufacturing method thereof provided by the embodiments of the present disclosure, an interface layer can be formed by crystallization between the anode current collector and the anode, and the interface layer has a relatively high ion transport property and can have a relatively good crystallization property at a relatively low annealing temperature or deposition temperature, so that low-temperature film formation can be achieved, cost reduction can be achieved, production efficiency can be improved, large-scale production of thin-film batteries can be facilitated, and Coulombic efficiency of the battery can be improved, and cycle life and capacity retention rate can be increased.

### BRIEF DESCRIPTION OF THE DRAWINGS

FIG. 1 is a schematic diagram showing the structure of an all-solid-state thin-film battery in the related art;

FIG. 2 is a schematic diagram showing the structure of a lithium-free thin-film battery in the related art;

FIG. 3 is a simplified schematic diagram showing the structure of a lithium-free thin-film battery assembly according to some embodiments provided by the present disclosure;

FIG. 4 is a simplified schematic diagram showing the structure of a regular all-solid-state thin-film battery assembly according to some embodiments provided by the present disclosure;

FIG. 5 is a schematic diagram showing the structure of a lithium-free thin-film battery assembly according to some embodiments provided by the present disclosure;

FIG. 6 is a top view of FIG. 5;

FIG. 7 is a graph showing XRD test results of a thin-film battery sample of Embodiment 1;

FIG. 8 is a graph showing XRD test results of a thin-film battery sample of a comparative example;

FIG. 9 is a graph showing cyclic voltammetry results of the thin-film battery sample of Embodiment 1;

FIG. 10 is a graph showing cyclic voltammetry results of the thin-film battery sample of the comparative example;

FIG. 11 is a graph showing the battery capacity versus voltage during a cyclic charge-discharge test of the thin-film battery sample of Embodiment 1;

FIG. 12 is a graph showing the number of cycles versus capacity during a cyclic charge-discharge test of the thin-film battery sample of Embodiment 1;

FIG. 13 is a graph showing the battery capacity versus voltage during a cyclic charge-discharge test of the thin-film battery sample of the comparative example;

FIG. 14 is a graph showing the number of cycles versus capacity during a cyclic charge-discharge test of the thin-film battery sample of the comparative example;

FIG. 15 is a graphical representation of etch results of etching selected regions of a battery assembly according to some embodiments of the present disclosure using an argon ion beam in depth profiling of the battery assembly using X-ray photoelectron spectroscopy (XPS);

FIG. 16 is an XPS high resolution spectrum of element Mo at an interface layer of a battery assembly according to some embodiments;

FIG. 17 is a graph showing the battery capacity versus voltage during a cyclic charge-discharge test of a flexible thin-film battery assembly;

FIG. 18 is a graph showing the number of cycles versus capacity during a cyclic charge-discharge test of a flexible thin-film battery assembly.

### DETAILED DESCRIPTION

In order that the objects, technical solutions and advantages of the embodiments of the present disclosure will become more apparent, a more particular description of the embodiments of the present disclosure will be rendered by reference to the appended drawings. It is to be understood that the described embodiments are part, but not all, of the disclosed embodiments. Based on the embodiments described in the present disclosure, all other embodiments obtained by a person of ordinary skill in the art without inventive effort fall within the scope of the present disclosure.

Unless defined otherwise, technical or scientific terms used in this disclosure shall have the ordinary meaning as understood by one of ordinary skill in the art to which this disclosure belongs. The terms “first”, “second”, and the like as use herein do not denote any order, quantity, or importance, but rather are used to distinguish one element from another. Likewise, terms such as “a”, “an”, or “the” do not denote a limitation on quantity, but rather denote the presence of at least one of the referenced items. The terms “including” or “comprising”, and the like, means that an element or item preceding the word encompasses the elements, items and equivalents thereof listed after the word, but does not exclude other elements or items. The terms “connecting” or “connected” and the like are not limited to physical or mechanical connections, but may include electrical connections, whether direct or indirect. The terms “upper”, “lower”, “left”, “right” and the like are used only to indicate relative positional relationships that may change accordingly when the absolute position of the object being described changes.

Before describing in detail the battery assembly and the manufacturing method thereof provided by the embodiments of the present disclosure, it is necessary to describe the related art as follows.

The sequence of metal activities, that is, the activity levels of metals, represents the reactivities of metals. Generally, in the activity series of metals, a metal in a back position has a relatively weak metallicity and a relatively weak atom reducibility; a metal in a front position has a relatively strong metallicity and a relatively strong atom reducibility. Generally, a descending order of activities of metals is: nickel, molybdenum, tin, lead, metallic hydrogen (H), copper, polonium, mercury, silver, palladium, platinum, gold.

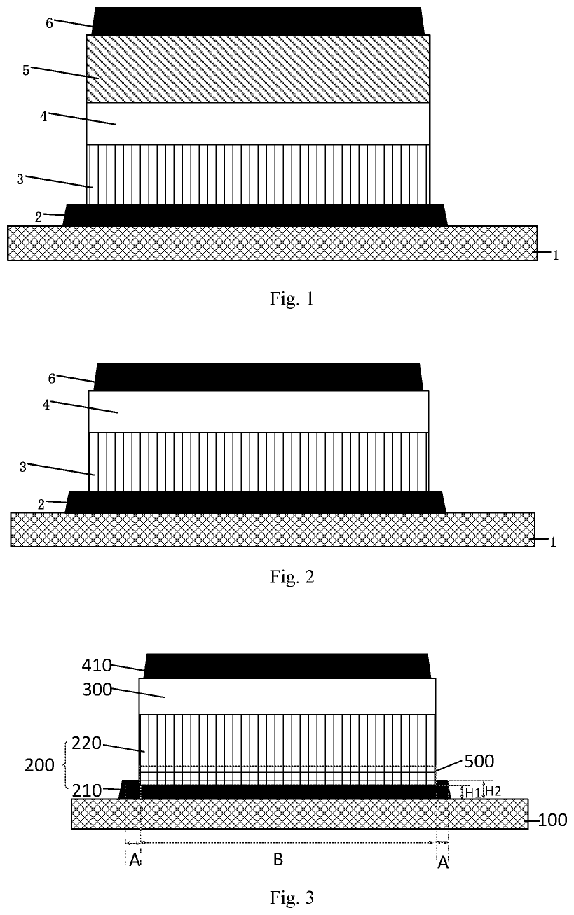

In the related art, as shown in FIG. 1, an all-solid-state thin-film battery generally includes the following five-layer structure: a substrate 1, an anode current collector 2, an anode 3, an electrolyte layer 4, a cathode 5 and a cathode current collector 6. As shown in FIG. 2, an all-solid-state thin-film “lithium-free” battery generally includes a four-layer structure: a substrate 1, an anode current collector 2, an anode 3, an electrolyte layer 4 and a cathode current collector 6.

In the related art, a metal after the metallic hydrogen in the activity series of metals is selected to form a current collector, for example: Cu, Ag, Au, Pt, etc., since these metals are chemically more stable, which is advantageous to reduce uncontrolled side reactions of the battery and improve cycle life. However, in the case of a lithium ion battery, the deposition temperature or annealing temperature of its anode is in general relatively high, for example, 500-700 degrees Celsius, and the crystallinity of the anode is increased by the high temperature. Thus, the process has high energy consumption and low production efficiency, cracking is prone to occur after the high temperature processing, and the process is not conducive to the large-scale production of thin-film batteries.

The inventors have found that if an interface layer is formed at the contact interface between the anode and the anode current collector, since the interface layer has a relatively high ion transport property, the interface layer can have a relatively good crystallization property at a relatively low annealing temperature or deposition temperature, so that low-temperature film formation can be achieved, the cost can be reduced, the production efficiency can be improved, the large-scale production of a thin-film battery can be facilitated, and the Coulombic efficiency of the battery can be improved, the cycle life and the capacity retention rate can be increased.

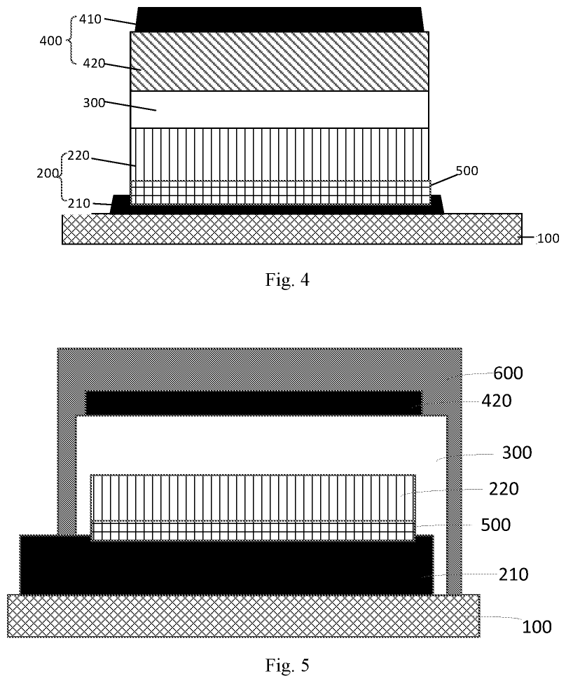

As shown in FIGS. 3 and 4, an embodiment of the present disclosure provides a battery assembly, including: an anode unit 200, an electrolyte layer 300, and a cathode unit 400; the anode unit 200 includes an anode current collector 210 and an anode 220 on the anode current collector 210; the electrolyte layer 300 is on a side of the anode unit 200 remote from the anode current collector 210; and the cathode unit 400 is on a side of the electrolyte layer 300 remote from the anode 220; the battery assembly further includes: an interface layer 500 formed at a contact interface between the anode current collector 210 and the anode 220.

In the above-mentioned solution, the interface layer 500 can be formed by crystallization between the anode current collector 210 and the anode 220, and the interface layer 500 has a relatively high ion transport property and can have a relatively good crystallization property at a relatively low annealing temperature or deposition temperature, so that low-temperature film formation can be achieved, cost reduction can be achieved, production efficiency can be improved, large-scale production of thin-film batteries can be facilitated, and Coulombic efficiency of the battery can be improved, and cycle life and capacity retention rate can be increased.

In order to form the interface layer 500 between the anode current collector 210 and the anode 220, illustratively, the anode current collector 210 is made from an active metal X, and the active metal X includes a pre-hydrogen metal which is a metal located before metallic hydrogen in activity series of metals. Using the above-mentioned scheme, the inventors have concluded through research that using a pre-hydrogen metal with a strong metal activity as the anode current collector 210 can reduce the annealing temperature after the deposition of the anode 220 is completed, and the interface layer 500 is spontaneously formed between the anode current collector 210 and the anode 220, and the interface layer 500 can provide the thin-film battery assembly with a higher oxidation potential, and improve the ion transport capacity, thereby improving the reversible capacity, the Coulombic efficiency and the rate performance.

It should be noted that, although the metal after the metallic hydrogen in the activity series of metals has been used in the related art because the chemical property of the metal after metallic hydrogen is more stable and can reduce irresistible side reactions of the batter, the inventors have found that, despite the fact that the activity of the pre-hydrogen metal is stronger, the reaction of the pre-hydrogen metal is a reversible reaction, which does not increase the irresistible side reactions of the battery, and the interface layer 500 generated between the pre-hydrogen metal and the anode 220 is more conducive to improving the ion transport capacity, thereby obtaining a larger battery capacity and obtaining a more excellent cycle performance.

Furthermore, in further embodiments of the present disclosure, the active metal is selected from transition metal materials. That is, the anode current collector 210 is preferably made from a transition metal among pre-hydrogen metals, for example, at least one or a combination of nickel, molybdenum, tin or lead.

The anode 220 may be made from a compound material containing lithium. Illustratively, the anode 220 is made from lithium oxide. Furthermore, the anode 220 may be made from a lithium transition metal oxide, such as LiCoO₂, LiMnO₂, etc.

The interface layer 500 may include a crystalline compound formed by crystallization of the metal X and the lithium oxide. The formula of the crystalline compound may be represented as LiₘXₙO_{y}, where the values of m, n and y depend on the valence state of the metal X, for example, if the metal X has a valence of +2, then the crystalline compound may be Li₂XO₂; if the metal X has a valence of +3, then the crystalline compound may be LiXO₂; when the metal X has a valence of +4, the crystalline compound may be Li₂XO₃, and so on.

In some embodiments, the interface layer includes a first subregion and a second subregion, a content of a high-valence metal X is greater than a content of a low-valence metal X in the first subregion, a content of the low-valence metal X is greater than a content of the high-valence metal X in the second subregion, a minimum distance between the first subregion and the anode is less than a minimum distance between the second subregion and the anode, and a minimum distance between the second subregion and the anode current collector is less than a minimum distance between the first subregion and the anode current collector.

Specifically, the interface layer is analyzed as follows.

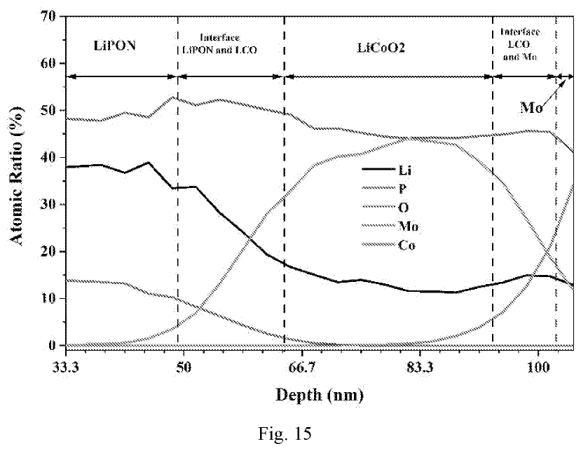

Supposing that the electrolyte layer is made from a LiPON (lithium phosphorous oxynitride) material, the anode is made from an LCO (lithium cobalt oxide) material, and the anode current collector is made from metal Mo (molybdenum), X-ray photoelectron spectroscopy (XPS) is used to perform depth profiling on the battery assembly provided by some embodiments of the present disclosure, in which an Ar (argon) ion beam is used to etch a selected region of the interface layer in the battery assembly, and the etching result is as shown in FIG. 15. After the XPS depth profiling of element distribution, the film layer structure can be divided into five regions: a region where the electrolyte layer (LiPON) is located, an interface region between the electrolyte layer (LiPON) and the anode (LCO), a region where the anode (LCO) is located, an interface layer, and an anode current collector region (Mo).

The interface layer is a crystalline interface layer having a thickness of 5-10 nm.

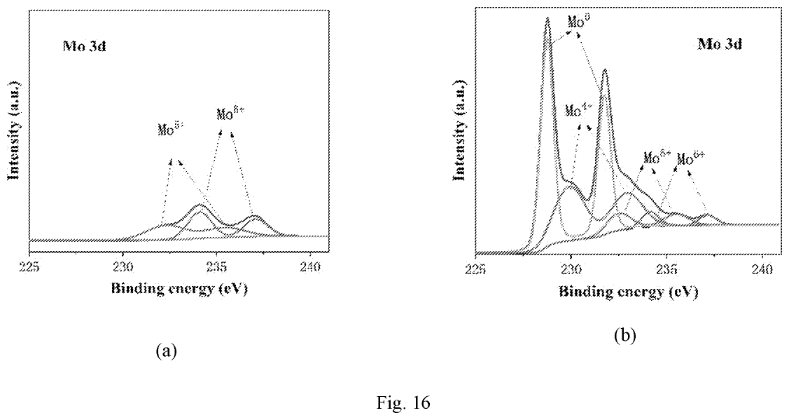

The XPS high resolution spectrum of element Mo in the interface layer is shown in FIG. 16. Due to spin-orbit splitting, the 3d peak of Mo of the same valence state is divided into two binding energy peaks. In FIG. 16, (a) is a high resolution spectrum of the interface of the interface layer close to the LCO, namely, a high resolution spectrum of the content of metal Mo in the region of the interface layer close to the anode. The high resolution spectrum indicates that the metal Mo is oxidized into Mo⁵⁺, Mo⁵⁺ components, and Mo⁶⁺ predominates. This interface region may have a lower valence component of element Mo due to insufficiency of O or Li therein. As the etching time increases, the probing depth is closer to the metal Mo (anode current collector). A high resolution spectrum of the interface of the interface layer close to the anode current collector is shown in FIG. 16 (b). The high resolution spectrum shows that most of the valence components of Mo are in a zero valence state, accompanied by high valence components of Mo⁴⁺, Mo₅₊, and Mo⁶⁺. Therefore, the interface layer includes a first subregion and a second subregion, a content of a high-valence metal X is greater than a content of a low-valence metal X in the first subregion, a content of the low-valence metal X is greater than a content of the high-valence metal X in the second subregion, a minimum distance between the first subregion and the anode is less than a minimum distance between the second subregion and the anode, and a minimum distance between the second subregion and the anode current collector is less than a minimum distance between the first subregion and the anode current collector. That is, the interface layer has a content of the high-valence metal X greater than a content of the low-valence metal X in a region close to the anode; the interface layer has a content of the low-valence metal X greater than a content of the high-valence metal X in a region near the anode current collector. Mo components of different valence states participate in the charge-discharge cycle while providing a large number of Li ion insertion sites, so that a large discharge capacity can be obtained.

The cathode current collector 410 may be made from a post-hydrogen metal which is a metal located after the metallic hydrogen in the activity series of metals, for example, at least one or a combination of copper, polonium, mercury, silver, palladium, platinum, gold, etc. The cathode unit 400 may be made from lithium.

In addition, the battery assembly provided by embodiments of the present disclosure may be applied in thin-film batteries, such as lithium-free thin-film batteries or regular all-solid-state thin-film batteries, and the like; it can also be applied in bulk-type batteries, such as button batteries, or consumer batteries.

In some embodiments, in the case that the battery assembly according to the embodiments of the present disclosure is a thin-film battery, e.g., lithium-free thin-film battery, as shown in FIG. 3, the cathode unit 400 may include only the cathode current collector 410. In other embodiments, as shown in FIG. 4, the battery assembly according to the embodiments of the present disclosure may also be a regular all-solid-state battery, and the cathode unit 400 thereof may include: a cathode 420 on a side of the electrolyte layer 300 remote from the anode unit 200, and a cathode current collector 410 on a side of the cathode 420 remote from the electrolyte layer 300.

In addition, in some embodiments, when the battery assembly is applied in a bulk-type battery, a metal substrate made from active metal X may be used as the substrate of the anode unit, and the metal substrate serves as the anode current collector as well. After the anode is formed on the substrate, the anode and the substrate, together as a single member, may be combined with the cathode unit.

It should be noted that the battery assembly provided by embodiments of the present disclosure may also be applied in flexible thin-film batteries, where the substrate 100 may be a flexible substrate 100. Since the annealing temperature after deposition of the anode may be as low as 300° C. when the active metal X is used as the anode current collector, there is limitations on the material of the flexible substrate. For example, the flexible substrate is made from one or more of polyimide, polymethyl methacrylate, polyethylene terephthalate, polyvinyl chloride and the like.

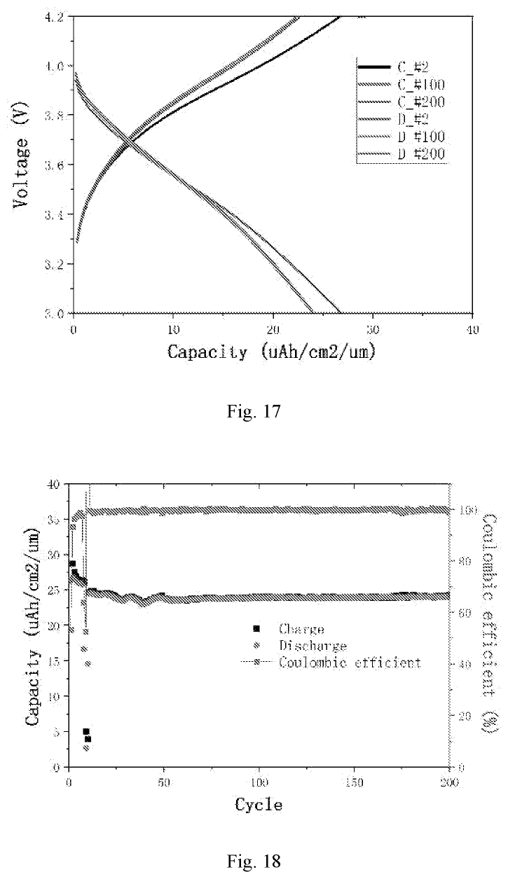

Charge-discharge test results of a flexible thin-film battery assembly employing a flexible substrate according to some embodiments of the present disclosure are shown in FIGS. 17 and 18. FIG. 17 is a graph showing the battery capacity versus voltage during a cyclic charge-discharge test of a flexible thin-film battery assembly, where the abscissa represents the battery capacity in units of μAh/cm²/μm and the ordinate represents the voltage in units of volts (V); FIG. 18 is a graph showing the number of cycles versus capacity during a cyclic charge-discharge test of a flexible thin-film battery assembly, where the abscissa represents the number of cycles and the ordinate represents the battery capacity in units of μAh/cm²/μm, and where the curve labelled with Charge represents the charge curve; the curve labelled with Discharge represents the discharge curve and the Coulombic efficient represents the Coulombic efficiency.

It can be concluded from FIG. 17 to FIG. 18 that: the flexible thin-film battery assembly according to the embodiments of the present disclosure is cycled at 3.3-4 V, has a relatively large cycling capacity, has a relatively high Coulombic efficiency which is greater than 99%, and has a capacity retention rate of 100% after cycling, and has a very high capacity retention rate.

In addition, the battery assembly according to the embodiments of the present disclosure may also be applied in rigid thin-film batteries, where the substrate 100 may be a rigid substrate 100. The rigid substrate is made from one or more of a metal, a rigid organic material, or a rigid inorganic material, such as SS metal (steel). Furthermore, in some embodiments, the interface layer 500 may have a thickness of 5-10 nm. Of course, this is only an example and is not limited to this in practical applications.

Furthermore, in some embodiments, as shown in FIG. 3, the anode current collector 210 includes a first face proximate to the anode and a second face opposite to the first face, and the first face includes a first region A covered by the anode and a second region B not covered by the anode, wherein a height H1 of an interface between the first region A and the interface layer 500 relative to the second face 210b is lower than a height H2 of the second region B relative to the second face. This is because, at the interface between the anode current collector and the anode, ions in the anode material will enter the anode current collector to spontaneously crystalize to form an interface layer, so that the height of the interface between the interface layer and the anode current collector is lower than the height of a region of the anode current collector where no crystallization occurs.

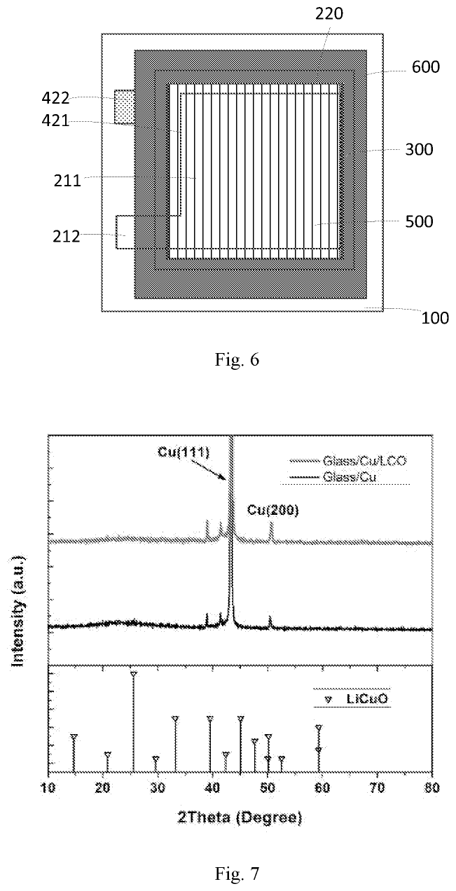

In addition, in some embodiments, the specific structure of a thin-film battery assembly provided by the present disclosure may be as shown in FIGS. 5 and 6. Taking the lithium-free thin-film battery shown in FIGS. 5 and 6 as an example, the lithium-free thin-film battery includes a substrate 100, an anode current collector 210, an anode unit 200, an electrolyte layer 300 and a cathode current collector 410 which are sequentially stacked from bottom to top. The pattern of the anode current collector 210 may include an anode main body portion 211 and an anode lead portion 212 extending from the anode main body portion 211, the anode 220 covers the main body portion, and the cathode current collector 410 covers the electrolyte layer 300, the cathode current collector 410 includes a cathode main body portion 411 and a cathode lead portion 412 extending from the cathode main body portion 411, the area of an orthographic projection of the electrolyte layer 300 onto the substrate 100 is greater than the area of an orthographic projection of the anode 220 onto the substrate 100, and the electrolyte layer 300 at least partially covers the side of the anode 220 facing away from the substrate and peripheral edges of the anode 220 so as to avoid a short circuit between the anode and the cathode.

In addition, in some embodiments, the specific structure of a thin-film battery assembly provided by the present disclosure may be as shown in the figures. Taking the regular all-solid-state thin-film battery shown in FIG. 4 as an example, the all-solid-state thin-film battery includes a substrate 100, an anode current collector 210, an interface layer 500, an anode 220, an electrolyte layer 300, a cathode 420 and a cathode current collector 410 which are sequentially stacked from bottom to top. The pattern of the anode current collector 210 may include an anode main body portion 211 and an anode lead portion 212 extending from the anode main body portion 211, the anode 220 covers the main body portion, the cathode 420 covers the electrolyte layer 300, the cathode current collector 410 covers the cathode 420, the current collector layer of the cathode unit 400 includes a cathode main body portion 411 and a cathode lead portion 412 extending from the cathode main body portion 411, the area of an orthographic projection of the electrolyte layer 300 onto the substrate 100 is larger than the area of an orthographic projection of the anode 220 onto the substrate 100, and the electrolyte layer 300 at least partially covers the side of the anode 220 facing away from the substrate and peripheral edges of the anode 220 to avoid short-circuit between the anode and cathode units.

In some embodiments, the side of the cathode current collector 410 remote from the substrate 100 may also be covered with a thin film encapsulation (TFE) laver.

In addition, the embodiments of the present disclosure also provide a method for manufacturing a thin-film battery assembly, which is applied for manufacturing the thin-film battery assembly according to the embodiments of the present disclosure. The method includes the steps of:

step S01, forming an anode current collector 210;

step S02, depositing an anode 220 on the anode current collector 210;

step S03, annealing the anode 220 to form an interface layer 500 at a contact interface between the anode current collector 210 and the anode 220;

step S04, forming an electrolyte layer 300 and a cathode unit 400 on a side of the anode 220 remote from the anode current collector 210;

step S05, forming an electrolyte layer 300 on a side of the anode 220 remote from the substrate 100; and

step S06, forming a cathode unit 400 on a side of the electrolyte layer 300 remote from the substrate 100.

In manufacturing the thin-film battery assembly, the step S01 specifically includes:

providing a substrate 100, depositing a metal layer on the substrate 100 by means of DC magnetron sputtering, and patterning the metal layer to obtain the anode current collector 210, where the anode current collector is made from an active metal X, and the active metal X includes a pre-hydrogen metal which is a metal located before metallic hydrogen in activity series of metals.

In the step S01, the metal layer may have a thickness between 100 nm and 500 nm; the metal layer may be patterned using an etching process.

In addition, the step S02 specifically includes: depositing an anode 220 by means of radio frequency magnetron sputtering, where the anode 220 is made from a compound material containing lithium.

In addition, in the step S03, the anode 220 is annealed at an annealing temperature of 300-800 degrees Celsius for 0.5-5 hours. Since an active pre-hydrogen transition metal is selected as the material of the anode current collector 210, the annealing temperature after the deposition of the anode 220 may be reduced to 300 degrees Celsius, which reduces the process energy consumption and improves the production efficiency.

Illustratively, the step S04 specifically includes:

step S041, depositing an electrolyte layer 300 on the anode 220 by means of radio frequency magnetron sputtering, wherein the thickness of the electrolyte layer 300 may be 10 nm to 10 μm;

step S042, depositing a cathode 420 on a side of the electrolyte layer 300 remote from the substrate 100 and depositing a cathode current collector 410 on a side of the cathode 420 remote from the electrolyte layer 300; or depositing a cathode current collector 410 on a side of the electrolyte layer 300 remote from the substrate 100.

In manufacturing a bulk-type battery, the step S01 specifically includes: providing a metal substrate made from an active metal X material, and patterning the metal substrate to obtain the anode current collector, where the active metal X includes a pre-hydrogen metal which is a metal located before metallic hydrogen in activity series of metals.

In the step S01, the metal substrate may have a thickness between 100 nm and 500 nm; the metal layer may be patterned using an etching process.

In addition, the step S02 specifically includes: depositing an anode 220 by means of radio frequency magnetron sputtering, where the anode 220 is made from a compound material containing lithium.

In addition, in the step S03, the anode 220 is annealed at an annealing temperature of 300-800 degrees Celsius for 0.5-5 hours. Since an active pre-hydrogen transition metal is selected as the material of the anode current collector 210, the annealing temperature after the deposition of the anode 220 may be reduced, for example, reduced to 300 degrees Celsius, which reduces the process energy consumption and improves the production efficiency.

Illustratively, the step S04 specifically includes: providing a cathode member including an electrolyte layer and a cathode unit, and combining the anode current collector and the anode, which are taken as a single member, with the cathode member.

In order to explain in more detail the thin-film battery assembly and the manufacturing method thereof according to the embodiments of the present disclosure, several specific embodiments are given below.

### Embodiment 1

In this embodiment, a thin-film battery sample is manufactured using the following steps.

At step S01, a substrate 100 is provided, a metal molybdenum (Mo) layer is deposited on the substrate 100 by means of direct current magnetron sputtering, and the metal molybdenum layer is patterned by photolithography to obtain an anode current collector 210.

The substrate 100 may be any suitable rigid substrate 100, such as a glass substrate 100; the metal molybdenum (Mo) layer may have a thickness of 100 nm to 500 nm. In a specific embodiment, the metal molybdenum (Mo) layer has a thickness of 200 nm.

At step S02, anode 220 material LiCoO₂ is deposit by means of radio frequency magnetron sputtering, where the thickness of the deposited film is 10 nm to 10 μm. In a specific embodiment, the anode 220 has a thickness of 30 nm.

At step S03, the deposited anode 220 material is subjected to low-temperature annealing with an annealing temperature of less than or equal to 300 degrees Celsius for 1 h. In a specific embodiment, the annealing temperature is kept at 300 degrees Celsius for 1 hour.

At step S041, a thin film is grown by radio frequency magnetron sputtering using a LiPO₃ (purity of 99.9% or more) target in a nitrogen (N₂) atmosphere or an atmosphere of nitrogen and argon (N₂+Ar), to obtain an electrolyte layer 300, where the electrolyte layer 300 has a thickness of 10 nm to 10 μm, preferably, 150 nm;

At step S042, according to the area size of the solid electrolyte thin-film, metal Cu is deposited as a cathode current collector 410, to obtain the lithium-free thin-film battery sample of Embodiment 1. The thickness of the metal Cu layer is not limited, and may be between 100 nm and 500 nm in this embodiment.

### Embodiment 2

In this embodiment, a thin-film battery sample is manufactured using the following steps.

At step S01, a substrate 100 is provided, a metal molybdenum (Mo) layer is deposited on the substrate 100 by means of direct current magnetron sputtering, and the metal molybdenum layer is patterned by photolithography to obtain an anode current collector 210.

The substrate 100 may be any suitable substrate 100, such as a glass substrate 100 or a flexible substrate 100; the metal molybdenum (Mo) layer may have a thickness of 100 nm to 500 nm. In a specific embodiment, the metal molybdenum (Mo) layer has a thickness of 200 nm.

At step S02, anode 220 material LiCoO₂ is deposit by means of radio frequency magnetron sputtering, where the thickness of the deposited film is 10 nm to 10 μm. In a specific embodiment, the anode 220 has a thickness of 30 nm.

At step S03, the deposited anode 220 material is subjected to low-temperature annealing with an annealing temperature of less than or equal to 300 degrees Celsius for 1 h. In a specific embodiment, the annealing temperature is kept at 300 degrees Celsius for 1 hour.

At step S041, a thin film is grown by radio frequency magnetron sputtering using a LiPO₃ (purity of 99.9% or more) target in a nitrogen (N₂) atmosphere or an atmosphere of nitrogen and argon (N₂+Ar) to obtain an electrolyte layer 300, where the electrolyte layer 300 has a thickness of 10 nm to 10 μm, preferably, 150 nm.

At step S042, metal lithium (Li) is deposited as a cathode 420 on the electrolyte layer 300 by means of magnetron sputtering; according to the area size of the solid electrolyte thin-film, metal Cu is deposited as a cathode current collector 410 to obtain the regular thin-film battery sample of Embodiment 1. The thickness of the metal Cu layer is not limited and may be between 100 nm and 500 nm in this embodiment.

### Embodiment 3

This embodiment uses the same steps as Embodiment 2, wherein the process parameters, etc. of each step are the same as Embodiment 2, and the only difference is that in this embodiment, at step S042, metal silicon (Si) is deposited as a cathode 420 on the electrolyte layer 300 by means of magnetron sputtering.

### Embodiment 4

This embodiment uses the same steps as Embodiment 1, wherein the process parameters, etc. of each step are the same as Embodiment 1, and the only difference is that a flexible substrate 100 is provided in step S01 in this embodiment.

### Embodiment 5

This embodiment uses the same steps as Embodiment 1, and the only difference is that the annealing temperature in step S03 in this embodiment is room temperature (about 25° C.).

### Embodiment 6

This embodiment uses the same steps as Embodiment 1, and the only difference is that the substrate in step S01 is a metal substrate.

### Embodiment 7

In this embodiment, a bulk-type battery sample is manufactured using the following steps.

At step S01, a metal substrate made from an active metal X material is provided, and the metal substrate is patterned to obtain the anode current collector. The active metal X includes a pre-hydrogen metal which is a metal located before metallic hydrogen in activity series of metals; the metal molybdenum (Mo) layer may have a thickness of 100 nm to 500 nm. In a specific embodiment, the metal molybdenum (Mo) layer has a thickness of 200 nm.

At step S02, anode 220 material LiCoO₂ is deposit by means of radio frequency magnetron sputtering, where the thickness of the deposited film is 10 nm to 10 μm. In a specific embodiment, the anode 220 has a thickness of 30 nm.

At step S03, the deposited anode 220 material is subjected to low-temperature annealing with an annealing temperature of 300-800 degrees Celsius for 0.5-5 h. In a specific embodiment, the annealing temperature is kept at 300 degrees Celsius for 1 hour.

At step S04, a cathode member including an electrolyte layer and a cathode unit is provided, and the anode current collector and the anode, which are taken as a single member, is combined with the cathode member.

It should be noted that the thin-film battery assembly and the manufacturing method thereof according to the embodiments of the present disclosure have been described above in connection with merely several embodiments, and since the length of the disclosure is limited, not all embodiments of the present disclosure are described, for example, different materials, different process parameters, etc. of the anode current collector are not described in detail herein.

In order to illustrate in more detail the thin-film battery assembly according to the embodiments of the present disclosure, the following comparative experiment was conducted.

Using the same steps and the same parameters as in Embodiment 1, a comparative thin-film battery sample was manufactured as a comparative example. The only difference from Embodiment 1 is that the anode current collector 210 in the thin-film battery sample of the comparative example was made from metal Cu.

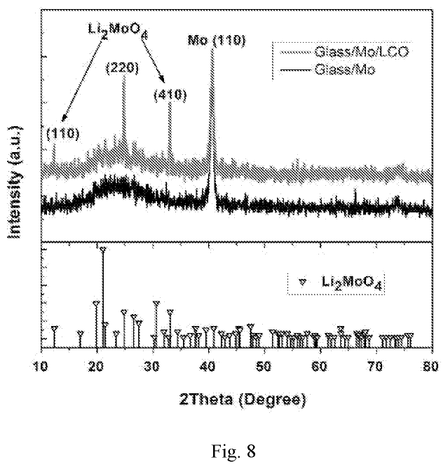

In the above-mentioned step S05, an XRD (X-ray diffraction, X-ray diffraction analysis) test was performed on the anode 220 in Embodiment 1 after annealing treatment, and the test results are shown in FIG. 7, where the abscissa is the diffraction angle value (2Theta) in degrees, the ordinate is the intensity in a.u. (arbitrary unit); XRD (X-ray diffraction analysis) test was performed on the anode 220 in Comparative Example 1 after annealing treatment, and the test results are shown in FIG. 8, where the abscissa is the diffraction angle value (2Theta) in degrees, the ordinate is the intensity value in a.u. (arbitrary unit). An obvious crystallization peak of LCO (cobalt lithium oxide) is not observed in FIG. 7, but a crystallization peak of LMO (molybdenum lithium oxide) appears, which indicates that the annealing treatment after the deposition of anode 220 and using metal Mo as the anode current collector 210 in Embodiment 1 lead to a new crystallization interface generated between the anode current collector 210 and the anode 220. No LCO or LiCuO (copper lithium oxide) crystallization peaks are found in FIG. 8, which indicates that using Cu as the anode current collector 210 in Comparative Example 1 does not lead to the same crystallization behavior as that in the case of using Mo as the anode current collector 210 in Embodiment 1.

In addition, it should be noted herein that FIG. 16 is an XPS high resolution spectrum of the element Mo in the interface layer. FIG. 16(a) is a high resolution spectrum of the interface of the interface layer close to the anode (LCO), namely, a high resolution spectrum of the content of metal Mo in the region of the interface layer close to the anode, and the high resolution spectrum indicates that the metal Mo is oxidized into Mo⁵⁺, Mo⁶⁺ components, and Mo⁶⁺ predominates. When the XPS high resolution spectrum of FIG. 16 and the XRD test results of FIG. 8 (Li₂MoO₄ is formed in the interface layer) are considered in combination, identical conclusions can be drawn.

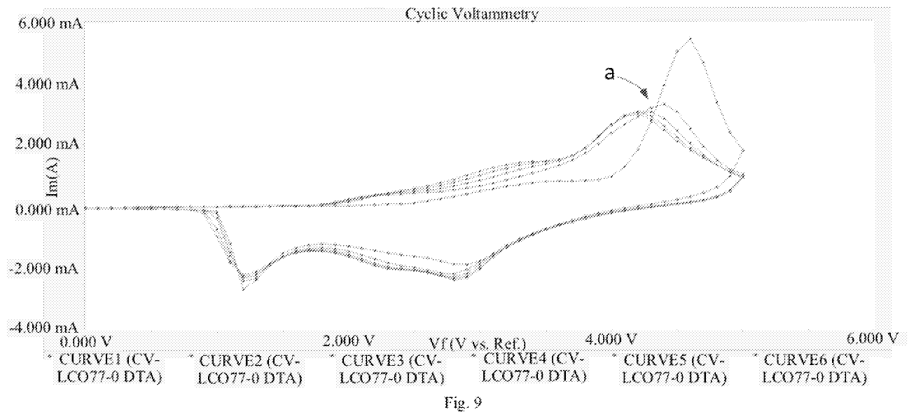

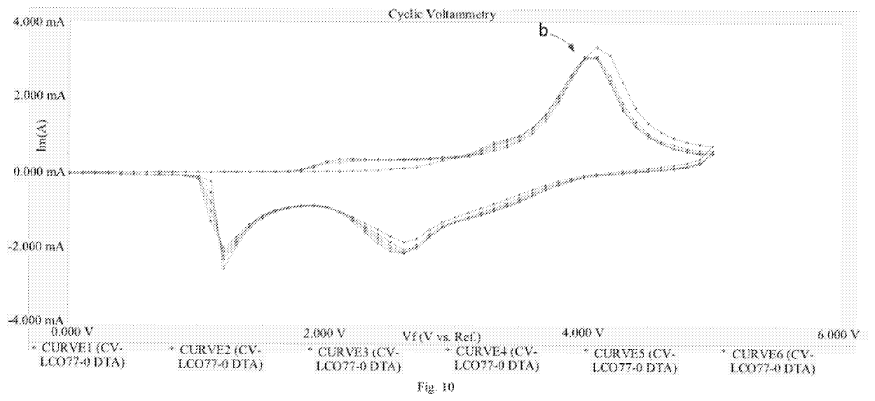

In addition, the prepared thin-film battery samples of Embodiment 1 and Comparative Example 1 were subjected to an electrochemical test and a cyclic charge-discharge test. Specifically, cyclic voltammetry (CV) tests were performed on the prepared thin-film battery sample of Embodiment 1 and the thin-film battery sample of Comparative Example 1, and the test results are shown in FIGS. 9 and 10. In FIGS. 9 and 10, the abscissa is the voltage in volts (V) and the ordinate is the current in amperes (A). From FIG. 9, it can be seen that the oxidation peak of the thin-film battery sample in Embodiment 1 is mainly located at 4.2 V (as shown by the arrow a in the figure), and from FIG. 10, it can be seen that the oxidation peak of the thin-film battery sample in the Comparative Example is mainly located at 4.0 V (as shown by the arrow b in the figure). As can be seen, the thin-film battery sample in Embodiment 1 has a larger oxidation potential than the thin-film battery sample in the Comparative Example.

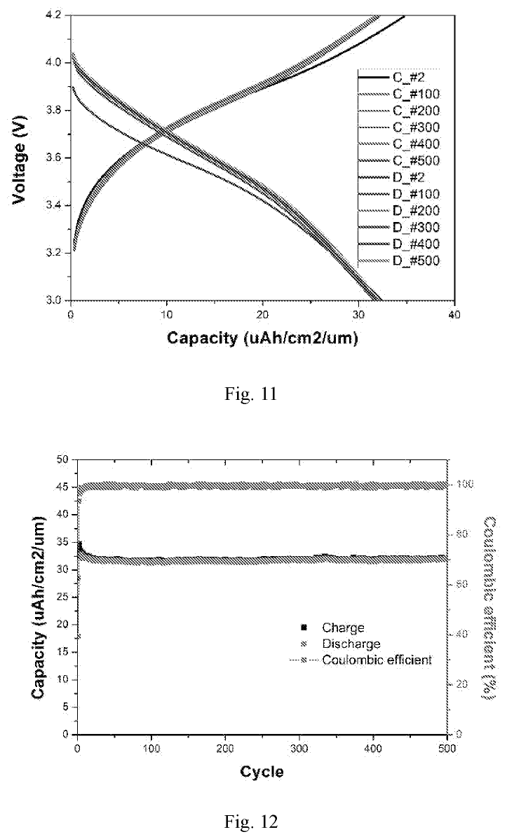

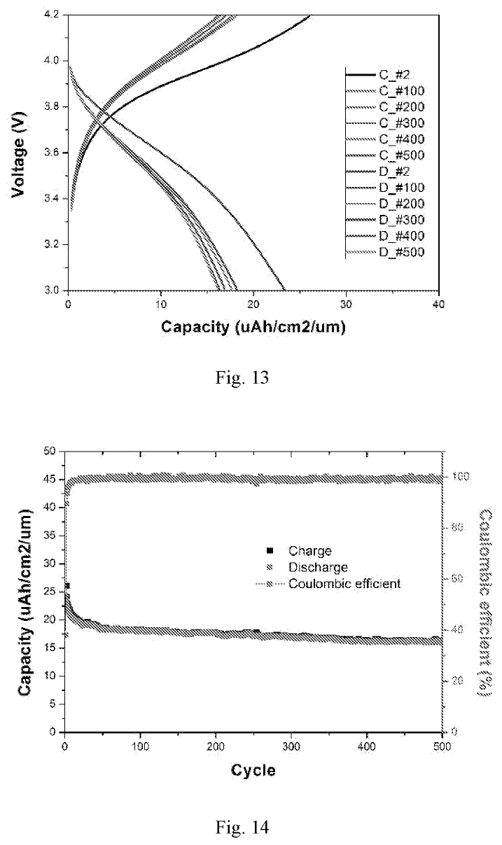

The prepared thin-film battery sample of Embodiment 1 and the thin-film battery sample of Comparative Example 1 were subjected to cyclic charge-discharge tests. Here, the test results of the thin-film battery sample of Embodiment 1 are shown in FIGS. 11 and 12. FIG. 11 is a graph showing the battery capacity versus voltage during a cyclic charge-discharge test of the thin-film battery sample of Embodiment 1; FIG. 12 is a graph showing the number of cycles versus capacity during a cyclic charge-discharge test of the thin-film battery sample of Embodiment 1; FIG. 13 is a graph showing the battery capacity versus voltage during a cyclic charge-discharge test of the thin-film battery sample of the comparative example; FIG. 14 is a graph showing the number of cycles versus capacity during a cyclic charge-discharge test of the thin-film battery sample of the comparative example. In FIGS. 11 to 13, the abscissa represents the battery capacity in μAh/cm²/μm, and the ordinate represents the voltage in volts (V). In FIGS. 12 and 14, the abscissa represents the number of cycles, the ordinate represents the battery capacity in μAh/cm²/μm, where Charge represents a charging curve and Discharge represents a discharging curve; Coulombic efficient stands for Coulombic efficiency. In FIG. 15, the abscissa indicates the depth in nanometers (nm), and the ordinate indicates the element component ratio (%). In FIG. 16, the abscissa represents the binding energy in eV, and the ordinate represents the intensity in a.u. (arbitrary unit).

The test results of the thin-film battery in the Comparative Example 1 are shown in FIGS. 13 and 14. From FIG. 11 to FIG. 14, it can be concluded that: the thin-film battery sample of Embodiment 1 was cycled at 3-4.2 V with a greater cycling capacity; the thin-film battery samples of Embodiment 1 and the Comparative Example both have high Coulombic efficiency, both being greater than 99%; the capacity retention rate after cycling of the thin-film battery sample of Embodiment 1 was 100%, while the capacity retention rate after cycling of the thin-film battery sample of Comparative Example 1 was 79%, indicating that the thin-film battery sample of Embodiment 1 has a higher capacity retention rate.

The following should be noted:
(1) The drawings relate only to the structures to which the embodiments of the present disclosure relate, and for other structures, references may be made to general designs.
(2) In the drawings used to describe embodiments of the present disclosure, the thickness of layers or regions is exaggerated or reduced for clarity, i.e., the drawings are not to scale. It will be understood that when an element such as a layer, film, region or substrate is referred to as being “on” or “under” another element, it can be “directly on” or “directly under” the other element or intervening elements may be present.
(3) Without conflict, embodiments of the present disclosure and features of the embodiments may be combined with each other to provide new embodiments.

The foregoing is directed to specific implementations of the present disclosure, but the scope of the disclosure is not limited thereto, and the scope of the disclosure is defined by the claims.

1. A battery assembly, comprising:
an anode unit, comprising an anode current collector and an anode on the anode current collector;
an electrolyte layer on a side of the anode remote from the anode current collector; and
a cathode unit on a side of the electrolyte layer remote from the anode;
wherein the battery assembly further comprises: an interface layer formed at a contact interface between the anode current collector and the anode.

2. The battery assembly according to claim 1, wherein
the anode current collector is made from an active metal X, and the active metal X comprises a pre-hydrogen metal which is a metal located before metallic hydrogen in activity series of metals.

3. The battery assembly according to claim 2, wherein
the active metal is selected from transition metal materials.

4. The battery assembly according to claim 3, wherein
the active metal comprises at least one or a combination of nickel, molybdenum, tin or lead.

5. The battery assembly according to claim 2, wherein
the anode is made from a compound material containing lithium.

6. The battery assembly according to claim 5, wherein
the anode is made from a lithium oxide, and the interface layer comprises a crystalline compound formed by crystallization of the metal X and the lithium oxide.

7. The battery assembly according to claim 1, wherein
the cathode unit comprises: a cathode on a side of the electrolyte layer remote from the anode, and a cathode current collector on a side of the cathode remote from the electrolyte layer; or,
the cathode unit only comprises: a cathode current collector on a side of the electrolyte layer remote from the anode.

8. The battery assembly according to claim 1, wherein
the battery assembly is a bulk-type battery, and the anode unit and the cathode unit are combined.

9. The battery assembly according to claim 1, wherein
the battery assembly is a thin-film battery, and further comprises a substrate on which the anode unit is located.

10. The battery assembly according to claim 9, wherein
the substrate is a flexible substrate or a rigid substrate.

11. The battery assembly according to claim 10, wherein
the flexible substrate is made from one or more of polyimide, polymethyl methacrylate, polyethylene terephthalate and polyvinyl chloride;
the rigid substrate is made from one or more of a metal, a rigid organic material, or a rigid inorganic material.

12. The battery assembly according to claim 1, wherein the interface layer is a crystalline interface layer, and the interface layer has a thickness of 5-10 nm.

13. The battery assembly according to claim 1, wherein
the anode current collector comprises a first face proximate to the anode and a second face opposite to the first face, and the first face comprises a first region covered by the anode and a second region not covered by the anode, wherein a height of an interface between the first region and the interface layer relative to the second face is lower than a height of the second region relative to the second face.

14. The battery assembly according to claim 2, wherein
the interface layer comprises a first subregion and a second subregion, a content of a high-valence metal X is greater than a content of a low-valence metal X in the first subregion, a content of the low-valence metal X is greater than a content of the high-valence metal X in the second subregion, a minimum distance between the first subregion and the anode is less than a minimum distance between the second subregion and the anode, and a minimum distance between the second subregion and the anode current collector is less than a minimum distance between the first subregion and the anode current collector.

15. A method for manufacturing a battery assembly, wherein the battery assembly comprises:
an anode unit, comprising an anode current collector and an anode on the anode current collector;
an electrolyte layer on a side of the anode remote from the anode current collector; and
a cathode unit on a side of the electrolyte layer remote from the anode;
wherein the battery assembly further comprises: an interface layer formed at a contact interface between the anode current collector and the anode;
wherein the method comprises:
forming the anode current collector;
depositing the anode on the anode current collector;
annealing the anode to form the interface layer at the contact interface between the anode current collector and the anode; and
forming the electrolyte layer and the cathode unit on the side of the anode remote from the anode current collector.

16. The method according to claim 15, wherein the battery assembly is a thin-film battery, and further comprises a substrate on which the anode unit is located; the forming the anode current collector specifically comprises:
providing the substrate, depositing a metal layer on the substrate by means of direct current (DC) magnetron sputtering, and patterning the metal layer to obtain the anode current collector, wherein the metal layer is made from an active metal X, and the active metal X comprises a pre-hydrogen metal which is a metal located before metallic hydrogen in activity series of metals;
or,
the battery assembly is a bulk-type battery, and the anode unit and the cathode unit are combined; the forming the anode current collector specifically comprises:
providing a metal substrate made from an active metal X, and patterning the metal substrate to obtain the anode current collector.

17. The method according to claim 15, wherein the depositing the anode on the side of the anode current collector remote from the substrate specifically comprises:
depositing the anode by means of radio frequency magnetron sputtering, wherein the anode is made from a compound material containing lithium.

18. The method according to claim 15, wherein the anode is annealed at an annealing temperature of 25-800 degrees Celsius for 0.5-5 hours.

19. The method according to claim 15, wherein the battery assembly is a thin-film battery, and further comprises a substrate on which the anode unit is located; the forming the electrolyte layer and the cathode unit on the side of the anode remote from the anode current collector specifically comprises:
depositing the electrolyte layer by means of radio frequency magnetron sputtering;
depositing the cathode on a side of the electrolyte layer remote from the substrate, and depositing the cathode current collector on a side of the cathode remote from the electrolyte layer; or depositing the cathode on the side of the electrolyte layer remote from the substrate.

20. The method according to claim 15, wherein the battery assembly is a bulk-type battery, and the anode unit and the cathode unit are combined; the forming the electrolyte layer and the cathode unit on the side of the anode remote from the anode current collector specifically comprises:
providing a cathode member comprising the electrolyte layer and the cathode unit, and combining the anode current collector and the anode, which are taken as a single member, with the cathode member.
